(19) United States
(12) Patent Application Publication
(10) Pub. No.: US 2026/0313500 A1
(43) Pub. Date: Oct. 8, 2026

(54) SEAMLESS MOBILITY DOMAIN SUPPORT SIGNALING

(71) Applicant: Cisco Technology, Inc., San Jose, CA (US)

(72) Inventors: Binita Gupta, San Diego, CA (US); Brian D. Hart, Sunnyvale, CA (US); Malcolm Muir Smith, Richardson, TX (US)

(21) Appl. No.: 19/640,725

(22) Filed: Apr. 7, 2026

Related U.S. Application Data
(60) Provisional application No. 63/980,610, filed on Feb. 11, 2026.
(60) Provisional application No. 63/784,655, filed on Apr. 7, 2025.

(51) Int. Cl. H04W 36/18; H04W 12/0431; H04W 36/00; H04W 60/04

(52) U.S. Cl. CPC H04W 36/18; H04W 12/0431; H04W 36/008357; H04W 60/04

(57) ABSTRACT

Seamless Mobility Domain (SMD) support signaling and roaming procedures may be provided. SMD support signaling includes operating, by an access point (AP) in an SMD, as an ultra high reliability (UHR) AP managing a basic service set (BSS) in a wireless network. The AP periodically transmits beacon frames to advertise the BSS to one or more client devices, wherein the beacon frames comprise a UHR element indicating that the AP supports seamless roaming within the SMD.

### RELATED APPLICATION

Under provisions of 35 U.S.C. § 119(e), Applicant claims the benefit of and priority to U.S. Provisional Application No. 63/784,655, filed Apr. 7, 2025, and U.S. Provisional Application No. 63/980,610, filed Feb. 11, 2026, the disclosures of which are incorporated herein by reference in their entirety.

### TECHNICAL FIELD

The present disclosure relates generally to providing Seamless Mobility Domain support signaling and roaming procedures.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for Seamless Mobility Domain (SMD) signaling and roaming procedures in accordance with aspects of the present disclosure.

FIG. 2 illustrates an example beacon frame for SMD support signaling in accordance with aspects of the present disclosure.

FIG. 3 illustrates an example UHR Operation element for SMD support signaling in accordance with aspects of the present disclosure.

FIG. 4 illustrates an example UHR Capabilities element in accordance with aspects of the present disclosure.

FIG. 5 illustrates another example UHR Capabilities element in accordance with aspects of the present disclosure.

FIG. 6 illustrates a signal process for SMD level reassociation using PMKSA caching in accordance with aspects of the present disclosure.

FIG. 7 is a flow diagram illustrating a method for SMD support signaling in accordance with aspects of the present disclosure.

FIG. 8 is a block diagram of a computing device in accordance with aspects of the present disclosure.

FIG. 9 is a block diagram of a communications device in accordance with aspects of the present disclosure.

### DETAILED DESCRIPTION

### Overview

Seamless Mobility Domain (SMD) support signaling and roaming procedures may be provided. SMD support signaling includes operating, by an access point (AP) in an SMD, as an ultra high reliability (UHR) AP managing a basic service set (BSS) in a wireless network. The AP periodically transmits beacon frames to advertise the BSS to one or more client devices, wherein the beacon frames comprise a UHR element indicating that the AP supports seamless roaming within the SMD.

Both the foregoing overview and the following example embodiments are examples and explanatory only and should not be considered to restrict the disclosure’s scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Roaming in Wi-Fi networks occurs when a client device (e.g., a Station (STA) or a non-Access Point Multi-Link Device (non-AP MLD)) transitions its connection from one Access Point (AP) or AP MLD to another, typically because the client device has moved outside the range of its serving AP or has identified another AP that can provide a better connection. Roaming decisions are primarily made by client devices based on Received Signal Strength Indicator (RSSI) measurements, supplemented by network recommendations from the serving AP regarding suitable neighbor APs.

Seamless roaming techniques have been developed to reduce roaming latency and improve user experience during AP transitions. Traditional non-MLD seamless roaming techniques include those described in Institute of Electrical and Electronics Engineers (IEEE) 802.11k, which reduce the time required to roam by enabling a client device to more quickly determine which AP it should roam to next, with the serving AP providing information regarding neighboring APs and their channels. Another non-MLD technique is described in IEEE 802.11r, which uses Fast Basic Service Set (BSS) Transition (FT) to allow encryption keys to be stored on all of the APs in a network, enabling a client device to avoid performing the complete authentication process to a backend server every time it roams to a new AP within the network, thus reducing authentication-related latency.

MLD-based seamless roaming as defined in the IEEE 802.11bn amendment introduces Seamless Mobility Domains (SMDs), which are logical groupings of multiple AP MLDs that enable client devices to roam between them without disconnecting, re-authenticating, re-associating, or experiencing packet loss. SMD-based seamless roaming enables a “make-before-break” approach where a device establishes a connection to a new AP MLD within the same SMD before releasing the connection with the previous AP MLD by utilizing multiple links. This allows the client device to maintain connectivity during the transition with minimum pause time, as the client device can communicate with both the serving AP MLD and the target AP MLD simultaneously over different links. The IEEE 802.11bn seamless roaming procedures include a roaming preparation phase during which the client device and serving AP exchange signaling to prepare one or more target APs for the upcoming roaming transition, followed by a roaming execution phase during which the actual transition to the target AP occurs. The roaming preparation phase may include negotiation of target APs, establishment of security associations with target APs, link setup, context transfer, and Quality of Service (QoS) related resource reservation on the target AP MLD, enabling the subsequent roaming execution to occur with minimal latency and data loss. Once a client device has performed roaming preparation with a target AP MLD, it then performs roaming execution to that target AP MLD to roam to that target AP. The roaming execution may involve dynamic context transfer and changing the Distribution System (DS) mapping for the client device from current AP MLD to the target AP MLD.

An SMD element is defined for APs to provide information for the SMD to which the APs belong. The SMD element provides an SMD identifier and SMD level capabilities, such as whether the SMD allows preparing multiple target AP MLDs, whether it supports data forwarding during roaming, and roaming preparation timeout values. The SMD element is typically provided in Probe Responses and (Re)Association Responses. However, due to Beacon bloating concerns, the IEEE 802.11bn amendment may restrict or otherwise discourage inclusion of static or semi-static parameters of a BSS in Beacon frames. Because the information in the SMD element are considered static or semi-static BSS parameters (e.g., the SMD identifier is static and SMD level capabilities and SMD parameters are relatively static), the AP MLDs may not include the SMD element in Beacons.

Without the presence of an SMD element in Beacon, a client device cannot determine based on a beacon frame whether an AP MLD is part of an SMD and supports seamless roaming (also referred to as SMD roaming or SMD BSS transition).. This creates a discovery problem for client devices attempting to identify seamless roaming capabilities during initial network scanning, as client devices typically rely on beacon frames for rapid AP capability assessment before initiating more resource-intensive probe request/response exchanges or before performing association.

Various SMD support signaling mechanisms are described herein for a client device to determine seamless roaming and SMD support without requiring the SMD element to be included in beacon frames. In one embodiment, all Ultra High Reliability (UHR) APs (e.g., APs in an SMD) are mandated to support seamless roaming functions, such that any indication that the AP is a UHR AP also signals support for seamless roaming. In another embodiment, a UHR Operation element or another UHR element (e.g. a UHR Capabilities element) included in the beacon frame carries an indication that seamless roaming (or SMD) is supported or enabled by the current AP deployment, such as by setting a ‘Seamless Roaming Supported,’ ‘Seamless Mobility Domain Supported,’ or ‘Seamless Roaming Enabled’ field or bit.

Additionally, mechanisms are described for distinguishing between SMD-level association support and SMD roaming support in client devices. For example, non-mobile client devices, such as stationary devices like refrigerators or televisions, may support SMD-level association to obtain the benefits of associating with an SMD without requiring full SMD roaming capabilities. Client devices can signal their SMD roaming capabilities (e.g., using an “SMD BSS Transition Supported” capability field) to enable AP MLDs to selectively transmit unsolicited roaming-related frames only to client devices that support SMD roaming.

Further, mechanisms are described for enabling reassociation with an SMD using Pairwise Master Key Security Association (PMKSA) Caching. A client device that associates with the SMD Management Entity (SMD-ME) of an SMD establishes an SMD-level Pairwise Master Key (PMK) that is valid for use across all AP MLDs in the SMD. The client device can subsequently perform PMKSA Caching-based reassociation with the same SMD through any AP MLD in the SMD using the SMD-level PMK, without requiring full authentication. This provides advantages for both when client devices need to reconnect to the SMD through a different AP MLD if their current AP MLD fails or becomes unreliable and when client devices need to perform emergency or urgent reassociation when insufficient time is available to complete the full SMD roaming preparation and execution procedure. This SMD-level PMKSA Caching mechanism provides an alternative to vendor-specific Opportunistic Key Caching (OKC) mechanisms.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, as used herein, reference to reading, writing, storing, buffering, and/or transferring data can include the entirety of the data, a portion of the data, a set of the data, and/or a subset of the data.

The terms “or,” “and/or,” “at least one of,” and “one or both of” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

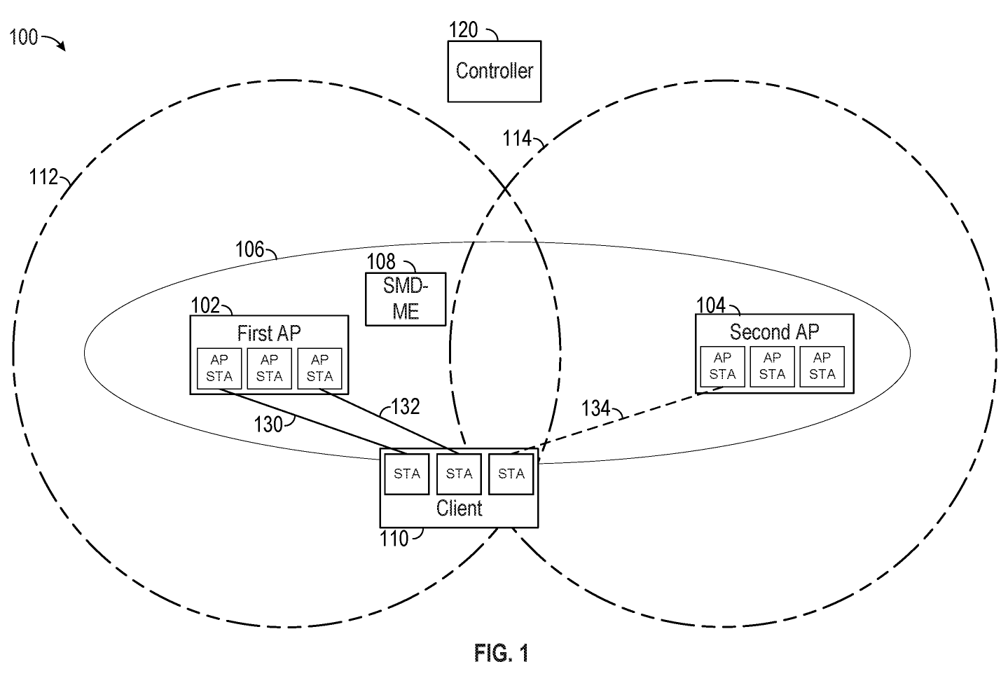

FIG. 1 is a block diagram of an operating environment 100 for SMD signaling and roaming procedures. In the illustrated embodiment, the operating environment 100 includes a first AP 102, a second AP 104, a client device 110, and a controller 120. The first AP 102 has a service area or cell indicated by the first cell 112, and the second AP 104 has a service area indicated by the second cell 114. The range of the first AP 102 and the second AP 104 may extend past the boundaries of the associated cells, resulting in overlapping coverage, but the signals grow weaker as devices move away from the respective APs. The edges of the first cell 112 and the second cell 114 as shown in the operating environment 100 are examples and may be different in other implementations (e.g., different sizes, shapes, etc.).

The APs in the operating environment 100 are grouped into one or more SMDs, such as the SMD 106 in the illustrated embodiment. The SMD 106 provides seamless roaming to clients across AP MLDs within the SMD 106. A client device 110 associates at the SMD level with an SMD-Management Entity (SMD-ME) 108 within the SMD 106 and then roams between AP MLDs within the SMD 106 without performing reauthentication or reassociation, to achieve seamless roaming. The SMD-ME 108 is a logical entity within the SMD 106. The first AP 102 and second AP 104 are part of the same SMD 106 in the illustrated embodiment.

The client device 110 is any device that connects to the network to communicate with other devices on the network, such as a smartphone, a tablet, a personal computer, a laptop, an Internet of Things (IoT) device, and/or the like. As illustrated in FIG. 1, the client device 110 is currently associated with the SMD 106 (e.g., via the SMD-ME 108), within the first cell 112, and connected with the first AP 102. However, the client device 110 may be moving toward the boundary of the first cell 112 and into the second cell 114, indicating that the client device 110 may soon need to roam from the first AP 102 to the second AP 104 or another neighbor AP to maintain network connectivity and quality of service (QoS).

An AP, such as the first AP 102 and the second AP 104, is generally a fixed station that communicates with client devices and may also be referred to as a base station, wireless device, or some other terminology. The APs support seamless roaming procedures (e.g., as defined in the IEEE 802.11bn amendment), including roaming preparation and roaming execution phases, which enable the client device 110 to transition between APs (e.g., AP MLDs) within the same SMD 106 with reduced roaming latency and data loss. The controller 120 may be any network controller (e.g., a WLAN controller) and may manage the first AP 102, the second AP 104, the SMD 106, the SMD-ME 108, and/or other network devices (not shown) to allow wireless devices such as the client device 110 to connect to the network. In some embodiments, the operations of the controller 120 described herein may be performed by one or more of the first AP 102, the second AP 104, and/or another device, and vice versa. In some embodiments, the controller 120 is included within or integrated with an AP and coordinates the links formed by that AP. In some embodiments, the controller 120 is separate from the APs and coordinates the links of multiple APs. The operating environment 100 is an example configuration and there may be a different number of clients, APs, controllers, and/or other devices in further examples.

As used herein, an AP along with the client devices associated with the AP (e.g., the client devices within the coverage area or cell of the AP) is referred to as a BSS. In the illustrated example, the first AP 102 is the serving or current AP for the client device 110 within the first cell 112. The APs may communicate with one or more client devices on the downlink (DL) and uplink (UL). The DL is the communication link from an AP to a client device 110, and the UL is the communication link from a client device 110 to an AP. In some cases, a client device 110 may also communicate peer-to-peer with another client device.

As shown in FIG. 1, the client device 110 and the APs are MLDs and each include one or more STAs. The client device 110 uses the STAs to form links with the AP STAs. For example, the client device 110 may use a first STA to form a first wireless link 130 with a corresponding STA of the first AP 102, and the client device 110 may use a second STA to form a second wireless link 132 with another STA of the first AP 102. Each STA may include Physical (PHY)-layer and lower-Media Access Control (MAC) components. The MLDs may also include an upper-MAC for coordinating the multiple STAs (or links) that are part of the MLD. The STAs can use different frequency bands for various wireless links. For example, the first wireless link 130 may be formed using a 5 GHz band and the second wireless link 132 may be formed using a 6 GHz band. These are example frequency bands and the wireless links may use any suitable frequency bands, including 2.4 GHz, 5 GHz, 6 GHz, 60 GHz or other bands.

In general, the AP(s) and the client device 110 may form any suitable number of links for communication using any suitable frequencies. In some instances, the client device 110 may form links with one AP (e.g., the first wireless link 130 and the second wireless link 132 with the first AP 102). In other instances, the client device 110 may form links with multiple APs (e.g., the first wireless link 130 and the second wireless link 132 with the first AP 102 and a third wireless link 134 with the second AP 104). As a result, the client device 110 may communicate with one or more APs over multiple links using different frequencies. Additionally, setup links may not always be active or otherwise useable. For example, the third wireless link 134 may be setup with the second AP 104 as part of roaming preparation, but the roaming execution may not have occurred yet. After roaming execution to the second AP 104, the third wireless link 134 becomes useable for data communication.

The controller 120 may provide coordination and control for the APs. For example, the controller 120 may handle adjustments to radio frequency power, channels, authentication, association, and security for the APs. The controller 120 may also coordinate the links formed by the client device(s) 110 with the APs. For example, the controller 120 may coordinate when the client device 110 and an AP communicate over a link using a particular frequency, the type of data communicated over a particular link, when the client device 110 and the AP form or terminate certain links, and/or when the client device 110 and AP (pre)-associate with each other to (pre)-establish certain links.

The client device 110 may be referred to as a STA MLD or non-AP MLD (e.g., a STA or client device acting as an MLD) and the first AP 102 or second AP 104 may be referred to as an AP MLD (e.g., an AP that acts as an MLD). The STA MLD and AP MLD are generally representative of any device capable of performing multi-link (ML) operations. An MLD may generally be classified based on whether it is a single radio MLD or multi-radio MLD. Single radio MLDs generally use a single radio (e.g., STA) to switch between one or more links. One category of single radio MLDs is Enhanced Multi-Link Single Radio (eMLSR). eMLSR devices generally operate one main wireless radio that can transmit and/or receive data frames on a given link, but can listen in low capability on a set of links when the device is not actively transmitting or receiving. Multi-radio MLDs may generally be classified into the following two types: (i) simultaneous transmission and reception (STR) MLD and (ii) non-STR MLD. For STR MLDs, a transmission on one link does not affect the operations of frame reception and clear channel assessment (CCA) on other links. For non-STR MLDs, the operation on one link may be restricted by the operation on another link. For example, a transmission on one link may not be allowed if it will cause reception interruption on another link.

In certain embodiments, the operating environment 100 enables the client device 110 to utilize seamless roaming techniques such as roaming without performing re-association with one or more APs, receiving neighbor reports to determine a target AP, and so on. As the client device 110 moves away from the coverage of an AP, the client device 110 may perform roaming preparation procedures to add links with a target AP MLD as it roams in the coverage of target APs within the SMD 106 to continue connectivity with the network. In certain embodiments, the beacons’ signal strength (e.g., RSSIs) from APs in the client device 110 roaming path acts as triggers for initiating roaming preparation to add links with target AP MLD(s).

In certain embodiments, the client device 110 can discover SMD support and seamless roaming capabilities through signaling mechanisms that do not require the SMD element to be included in beacon frames. For example, the APs may indicate seamless roaming and SMD support through UHR elements (such as the UHR Operation element or UHR Capabilities element) carried in beacon frames, through fields or bits in other new elements (e.g., Security Profile element) or existing elements carried in beacon frames (e.g., Capability Information field, Extended Capabilities element, or Robust Security Network extension element (RSNXE)), or by indicating the APs are UHR APs when all UHR APs are mandated to support seamless roaming. Additionally, the client device 110 may signal its seamless roaming capabilities, including to distinguish between support for SMD-level association versus full SMD roaming functionality. Furthermore, the operating environment 100 supports SMD-level PMKSA Caching, which allows the client device 110 to reassociate with the SMD 106 through any AP MLD in the SMD using an SMD-level Pairwise Master Key (PMK) without requiring full authentication.

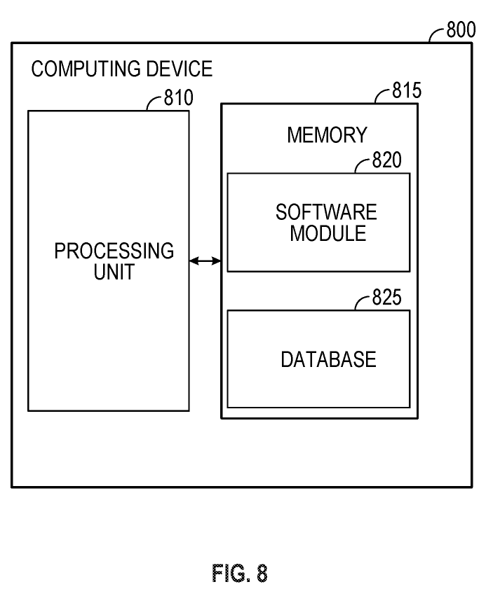

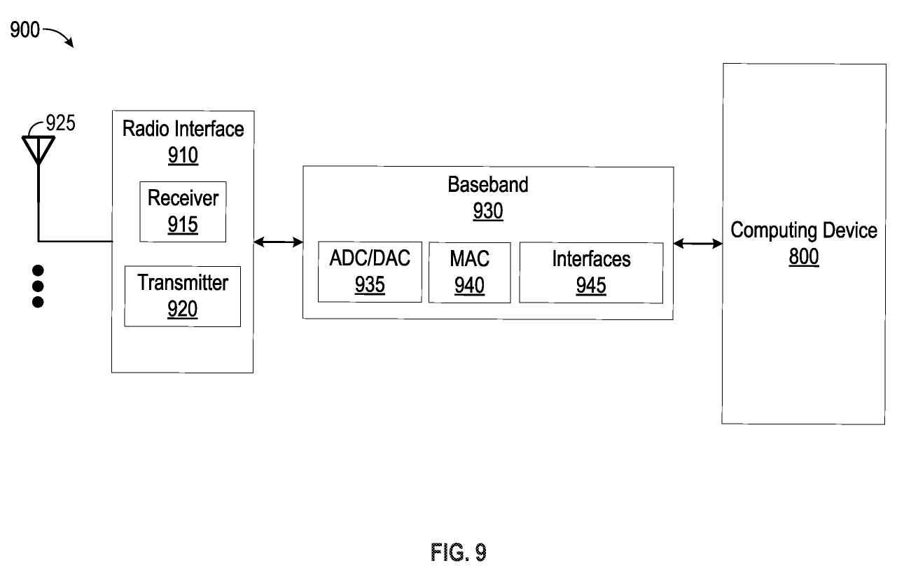

The elements described above of the operating environment 100 (e.g., the first AP 102, the second AP 104, the SMD-ME 108, the client device 110, the controller 120, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 8 and 9, the elements of the operating environment 100 may be practiced in a computing device 800 and/or communications device 900.

### Seamless Roaming and SMD Functionality Signaling Using Beacon Frames

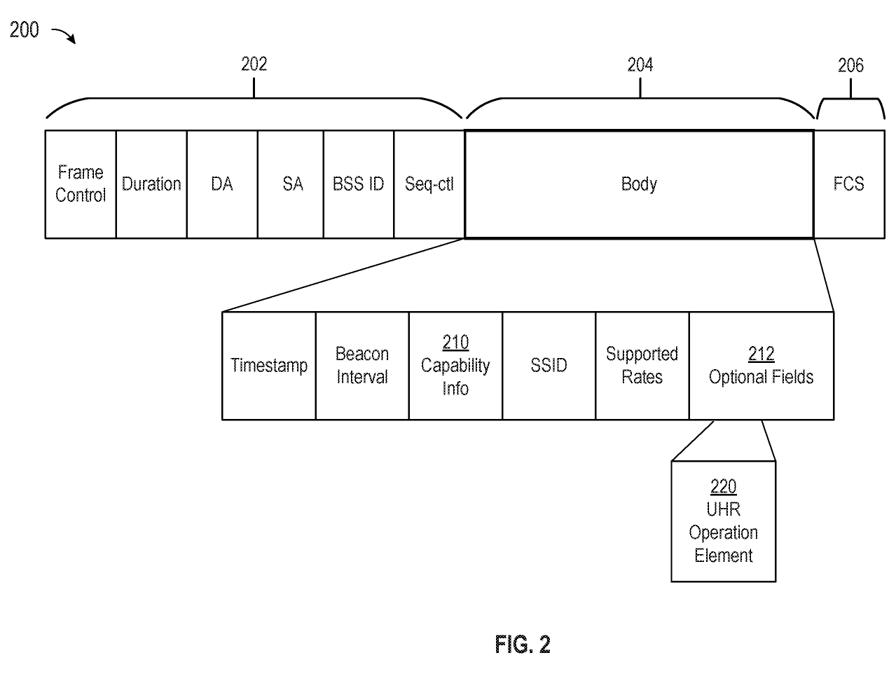

FIG. 2 illustrates an example beacon frame 200 for SMD support signaling. The beacon frame 200 includes a header 202, a body 204, and a footer 206. In example implementations, the header 202 is a MAC header and the footer 206 comprises a frame check sequence. The body 204 includes, among other fields, a capability information field 210 and optional fields 212. In the illustrated embodiment, the optional fields 212 include a UHR Operation element 220.

In some embodiments, UHR APs are mandated to support seamless roaming functions. In this case, any indication that an AP is a UHR AP also signals support for seamless roaming. For example, the presence of the UHR Operation element 220 in the beacon frame 200 signals that the transmitting AP is a UHR AP and therefore supports seamless roaming. When the first AP 102 transmits a beacon frame 200 containing the UHR Operation element 220, the client device 110 determines that the first AP 102 supports seamless roaming and SMD operations. The client device 110 can then acquire detailed SMD parameters (e.g., including the SMD identifier and SMD-level capabilities and parameters) by sending a Probe Request and receiving an SMD element in the Probe Response or by using another management frame exchange to retrieve SMD element (also referred to as SMD Information element).

In certain embodiments, even when seamless roaming is mandatory for device (e.g. AP) certification, a given deployment may choose not to enable seamless roaming in the field. Implementation and enablement are distinct: seamless roaming may be required to be implemented in all UHR APs for certification purposes while enablement for seamless roaming may remain optional in any particular network. The APs must therefore signal whether seamless roaming is currently enabled, not merely whether they are UHR APs when seamless roaming is not required to always be enabled.

Because static BSS parameters, including the SMD element (also referred to as SMD Information element), may be omitted from beacon frames 200 to minimize beacon bloating, a client device 110 cannot determine whether an AP is part of an SMD and supports seamless roaming in the traditional way utilizing the SMD element. Thus, when UHR APs are not required to support seamless roaming and need to signal whether SMD and seamless roaming is supported, the APs in an SMD 106 can signal SMD and seamless roaming support in various ways. For example, the UHR Operation element 220 or another UHR element or a new element (e.g. Security Profiles element) in the beacon frame 200 carries an indication that seamless roaming or SMD operation is supported by the AP in the current deployment. Example fields that can convey this indication include a ‘Seamless Roaming Supported,’ ‘Seamless Mobility Domain Supported,’ or ‘Seamless Roaming Enabled’ field (e.g., a single bit field). In example implementations, all affiliated APs of a UHR AP MLD that is part of an SMD set this field to a value indicating seamless roaming support (e.g., a value of 1), and to another value otherwise (e.g., a value of 0).

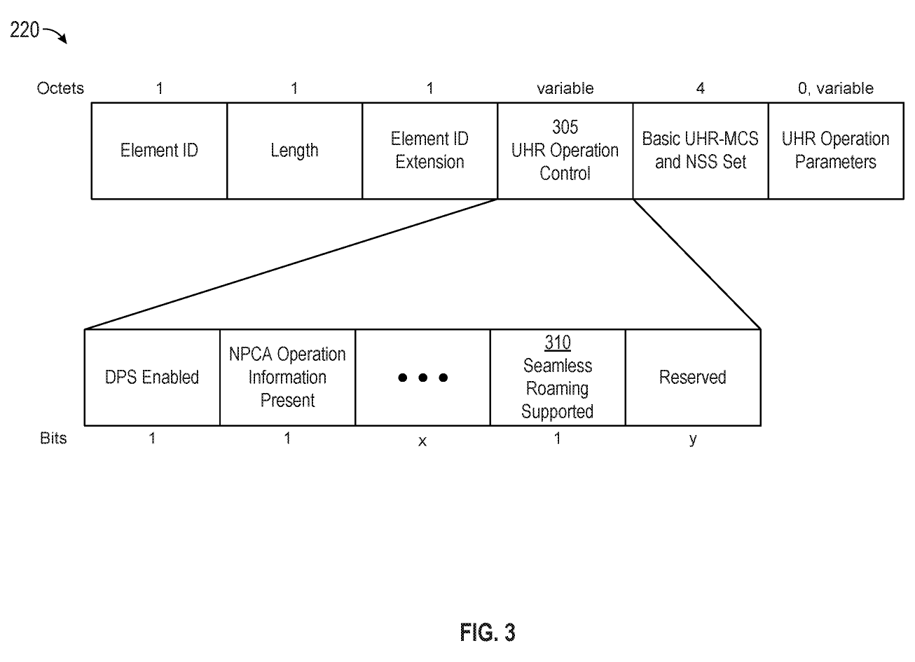

FIG. 3 illustrates an example UHR Operation element 220. The UHR Operation element 220 includes, among other fields, a UHR Operation Control field 305. The UHR Operation Control field 305 includes a seamless roaming supported field 310 that can be set to indicate support for seamless roaming. In example implementations, the seamless roaming supported field 310 is one bit in length and is set to a first value (e.g., 1) to indicate that seamless roaming is supported and to a second value (e.g., 0) to indicate that seamless roaming is not supported. In further embodiments, the field 310 may be defined as a seamless roaming enabled field, an SMD supported field, or a similar indicator.

In certain embodiments, additional key SMD capabilities may also be signaled within the UHR Operation element 220. For example, a bit or field can indicate support for Data Forwarding between AP MLDs of the SMD 106 (e.g., to ensure clients receive critical SMD operational information directly from the beacon without requiring active probing).

When a client device 110 determines from the beacon frame 200 that an AP supports seamless roaming, the client device 110 can retrieve full SMD information by transmitting a Probe Request or another frame to the AP and receiving an SMD element in the corresponding Probe Response, or by receiving the SMD element in a (Re)Association Response.

In some embodiments, the seamless roaming or SMD support indication is carried in a field or element other than the UHR Operation element 220. For example, one or more bits may be set in the capability information field 210, an extended capabilities element in the optional fields 212, an RSNXE in the optional fields 212, or another existing or new element carried in the beacon frame 200.

### Seamless Roaming and SMD Functionality Signaling Using UHR Capabilities Element

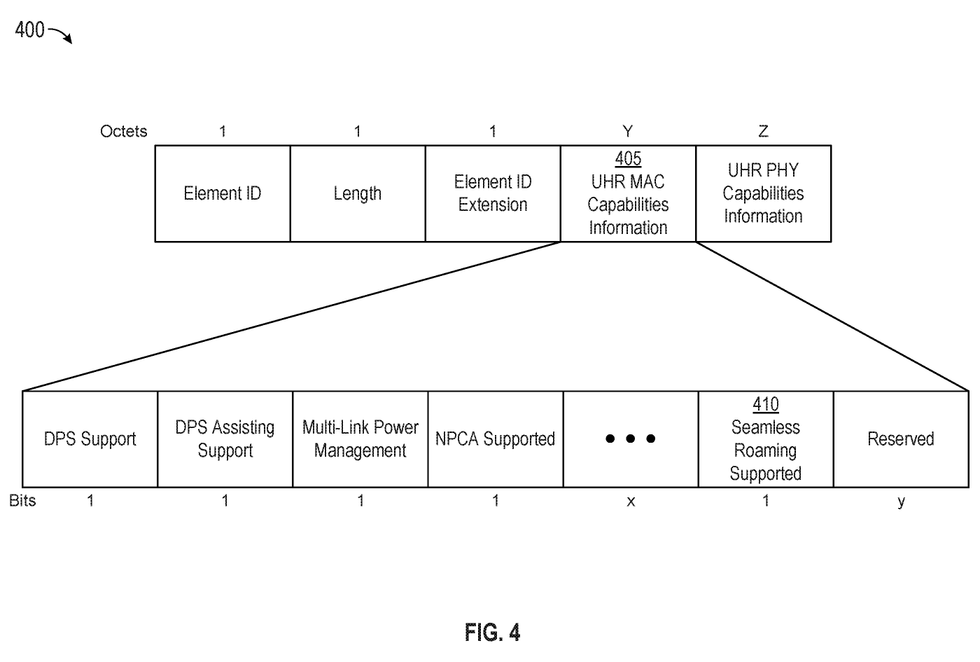

FIG. 4 illustrates an example UHR Capabilities element 400. A client device declares itself as a UHR STA by transmitting the UHR Capabilities element 400 during association or probe exchanges. The UHR Capabilities element 400 contains a number of fields used to advertise the UHR capabilities of the transmitting STA and includes, among other fields, a UHR MAC Capabilities Information field 405.

A client device 110 that supports SMD functionality and seamless roaming can advertise that support using one or more bits in the UHR MAC Capabilities Information field 405. In the illustrated embodiment, the UHR MAC Capabilities Information field 405 includes a seamless roaming supported field 410 for this purpose. A UHR STA that supports seamless roaming and/or SMD functionality sets the seamless roaming supported field 410 to a first value (e.g., 1) to indicate support, and to a second value (e.g., 0) to indicate the absence of support. Where the client device 110 is a UHR non-AP MLD, all affiliated Non-AP STAs of that MLD may set the field 410 to the same value, ensuring consistent capability signaling across all links of the MLD.

In some embodiments, seamless roaming support is mandated for all UHR client devices (e.g., UHR non-AP MLDs). In that case, the seamless roaming supported field 410 need not be present in the UHR Capabilities element 400, because support can be inferred from the device’s UHR status alone. If the field 410 is included despite support being mandatory, it is always set to the value indicating support.

In certain embodiments, APs within an SMD may also use the UHR MAC Capabilities Information field 405 to signal seamless roaming support. A UHR AP MLD that supports seamless roaming and participates in an SMD can set the seamless roaming supported field 410, or another designated bit in the field 405, to indicate that support. As with non-AP MLDs, the affiliated APs of the UHR AP MLD may each set the field to the same value to maintain consistent signaling for seamless roaming support across all the affiliated APs of the AP MLD.

In another embodiment, rather than using the fields described with respect to FIGS. 3 and 4, an AP signals seamless roaming support and/or SMD functionality implicitly through the inclusion of a seamless roaming-specific element, such as the SMD element (also known as SMD Information element), in Beacons and/or Probe Responses. Under this approach, the presence of the SMD element itself serves as the support indication for SMD roaming. Accordingly, UHR AP MLDs that are not part of any SMD, and for which seamless roaming support is not mandatory, omit the SMD element from their Beacons and Probe Responses, and the absence of the element signals to client devices that seamless roaming is not available through that AP.

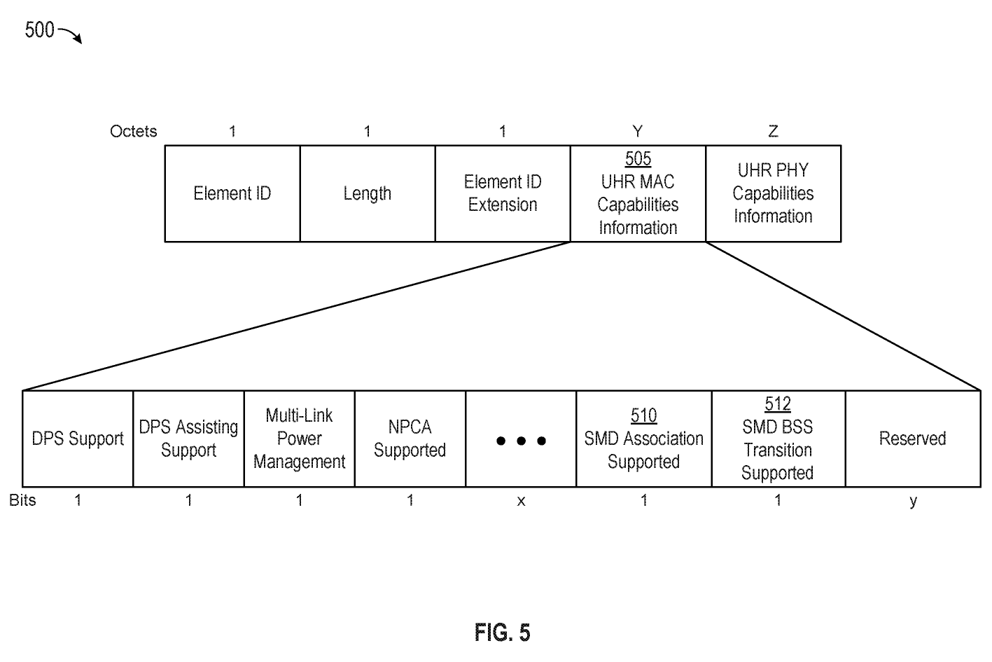

FIG. 5 illustrates another example UHR Capabilities element 500 that separately signals SMD level association support and seamless roaming support. The UHR Capabilities element 500 includes a UHR MAC Capabilities Information field 505 comprising an SMD Association Supported field 510 and an SMD BSS Transition Supported field 512 in the illustrated embodiment. In other embodiments, the SMD Association Supported field 510 is omitted where SMD level association capability is conveyed through another mechanism.

The distinction between the two fields reflects the fact that SMD level association and seamless roaming are separable capabilities. A client device 110 may associate with the SMD 106 (e.g., with the SMD-ME 108, without being capable of or needing to perform seamless roaming. For example, a non-mobile client device may benefit from SMD level association for centralized authentication and policy management while having no need to perform BSS transitions between AP MLDs within the SMD. Accordingly, support for SMD level association does not imply support for seamless roaming, and these two capabilities can be signaled independently.

The client device 110 uses the SMD BSS Transition Supported field 512 to explicitly indicate whether it supports seamless roaming. The client device 110 sets the field 512 to a first value (e.g., 1) to indicate seamless roaming support and to a second value (e.g., 0) to indicate the absence of such support. The client device 110 may separately indicate SMD association support using the SMD Association Supported field 510. In some embodiments, UHR APs may be required by the applicable standard to support SMD association, while SMD association support for UHR client devices may be defined as mandatory or optional.

The separate signaling of these capabilities has direct operational consequences for AP behavior. An AP MLD should transmit unsolicited frames related to SMD roaming, such as unsolicited BSS Transition Management (BTM) Request frames recommending candidate neighboring AP MLDs, only to client devices that have both associated with the SMD-ME 108 and explicitly indicated support for SMD roaming (e.g., via the SMD BSS Transition Supported field 512). A client device that has associated with the SMD-ME 108 but has not indicated SMD roaming support should not receive such unsolicited frames, as they are not actionable by that client device. On the network side, an SMD advertised by AP MLDs implies that the SMD also supports SMD roaming.

### SMD Level Reassociation Using PMKSA Caching

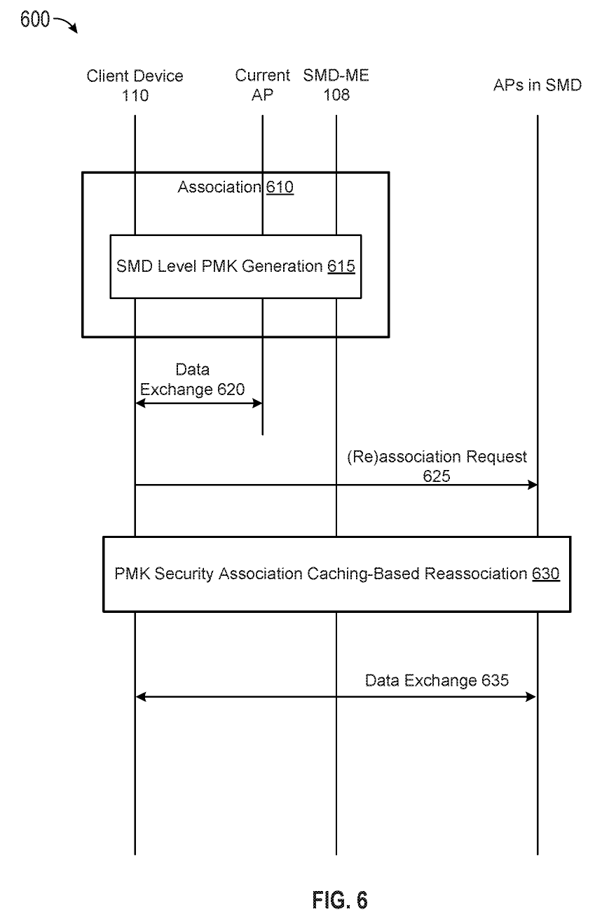

FIG. 6 illustrates a signal process 600 for SMD level reassociation using PMKSA caching. During initial SMD level association, a client device that associates with an SMD-ME 108 through a current AP MLD establishes an SMD level PMK that is valid across all AP MLDs within the SMD 106. The corresponding PMKSA, including its PMKID, can then be reused for subsequent reassociation to the same SMD through any of its member AP MLDs without requiring full reauthentication, e.g can be used when reassociating with the SMD-ME through another target AP MLD in the same SMD.

At stage 610, the client device 110 performs an initial association with the SMD-ME 108, through a current AP MLD in the SMD. As part of this process, an SMD level PMK is generated at substage 615, and the resulting PMKSA (that includes the SMD level PMK and a PMKID) is cached by the client device 110 and shared across all AP MLDs of the SMD 106, or can be fetched/pulled by any AP MLD of the SMD from a common place such as Controller of a key store.

Following successful association, the client device 110 exchanges data through the current AP MLD in the SMD 106 at stage 620. At stage 625, the client device 110 determines to perform reassociation with the SMD. This may occur, for example, because the client device’s current AP MLD has gone down, the link quality to the current AP MLD has degraded, or the client device did not have sufficient time to complete the full seamless roaming procedure, including roaming preparation and execution, before the link became unreliable. Rather than initiating a full authentication exchange, the client device 110 sends a (Re)Association Request to any AP MLD within the same SMD 106. The request indicates that it is a reassociation to the SMD (e.g., by including an SMD Information element) and includes in the RSNE, or another applicable element, the PMK identifier (PMKID) corresponding to the SMD level PMK. Because the SMD level PMK is shared across all AP MLDs of the SMD 106 (or can be fetched/pulled by any AP MLD of the SMD from a common place such as Controller of a key store), any member AP MLD of the SMD can validate the received PMKID in the (Re)Association Request and complete the reassociation without a full authentication needed. At stage 630, the client device and the target AP MLD completes the PMKSA caching based reassociation, establishing a new association with the SMD through the selected target AP MLD. The client device 110 then resumes data exchange through the target AP MLD in the SMD 106 at stage 635.

Upon successful PMKSA caching-based reassociation, the association timer for the client device 110 with the SMD and SMD-ME 108 is reset, maintaining continuity of the SMD level association. This mechanism provides a standards-defined analog to vendor-specific mechanisms such as Opportunistic Key Caching (OKC), enabling faster reassociation to the SMD through any member AP MLD. Notably, this benefit is available regardless of whether the client device 110 supports SMD roaming. Even a client device that supports only SMD level association and not seamless roaming can leverage the SMD level PMKSA to avoid full reauthentication when reconnecting to the same SMD. In some embodiments, even a client device 110 that does support SMD roaming may elect to use PMKSA caching-based reassociation in circumstances where completing the full seamless roaming procedure is not feasible.

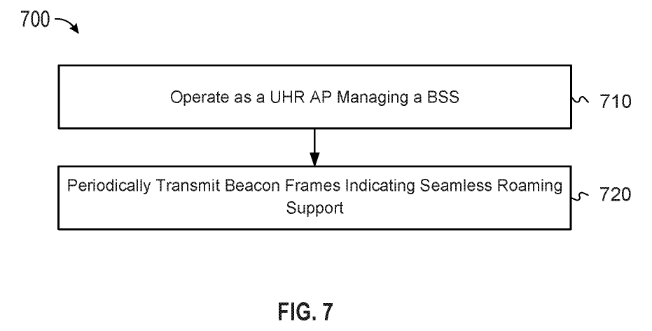

FIG. 7 is a flow diagram illustrating a method 700 for SMD support signaling. At stage 710, an AP operates as a UHR AP managing a BSS in a wireless network, wherein the AP is part of an SMD. At stage 720, the AP periodically transmits beacon frames to advertise the BSS to one or more client devices, wherein the beacon frames comprise a UHR element indicating that the AP supports seamless roaming within the SMD.

In some embodiments, UHR APs are mandated to support seamless roaming, and the presence of the UHR element in the beacon frame itself serves as the indication of seamless roaming support. In certain embodiments, the UHR element comprises a field, such as a Seamless Roaming Supported field within a UHR Operation Control field or a UHR Operation Parameters field of a UHR Operation element, configured to be set to a first value to indicate seamless roaming support and to a second value to indicate the absence of such support.

In certain embodiments, the AP receives from a client device a UHR Capabilities element comprising a Seamless Roaming Supported field set to a first value to indicate that the client device supports seamless roaming and to a second value to indicate that it does not. In some embodiments, the UHR Capabilities element comprises an SMD Association Supported field indicating whether the client device supports SMD level association and an SMD BSS Transition Supported field indicating whether the client device supports seamless roaming. In certain embodiments, the AP indicates support for seamless roaming in a UHR Capabilities element.

In certain embodiments, the AP receives from a client device a (Re)Association Request comprising an SMD Information element indicating that the request is a reassociation to the SMD and a PMKID corresponding to an SMD level PMK established during a prior SMD level association. The AP then performs PMKSA caching-based reassociation with the client device using the SMD level PMK.

FIG. 8 is a block diagram of a computing device 800. As shown in FIG. 8, computing device 800 may include a processing unit 810 and a memory unit 815. Memory unit 815 may include a software module 820 and a database 825. While executing on processing unit 810, software module 820 may perform, for example, processes for providing SMD support signaling and roaming procedures. Computing device 800, for example, may provide an operating environment for the first AP 102, the second AP 104, the SMD-ME 108, the client device 110, the controller 120, and the like. The first AP 102, the second AP 104, the SMD-ME 108, the client device 110, the controller 120, and the like may operate in other environments and are not limited to computing device 800.

Computing device 800 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 800 may comprise any computer operating environment, such as hand-held devices, multiprocessor systems, microprocessor-based or programmable sender electronic devices, minicomputers, mainframe computers, and the like. Computing device 800 may also be practiced in distributed computing environments where tasks are performed by remote processing devices. The aforementioned systems and devices are examples, and computing device 800 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a SOC where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 800 on the single integrated circuit (chip).

FIG. 9 illustrates an implementation of a communications device 900 that may implement one or more of the first AP 102, the second AP 104, the SMD-ME 108, the client device 110, the controller 120, etc. In various implementations, the communications device 900 may comprise a logic circuit. The logic circuit may include physical circuits to perform operations described for one or more of the first AP 102, the second AP 104, the SMD-ME 108, the client device 110, the controller 120, etc., for example. As shown in FIG. 9, the communications device 900 may include one or more of, but is not limited to, a radio interface 910, baseband circuitry 930, and/or the computing device 800.

The communications device 900 may implement some or all of the structures and/or operations for the first AP 102, the second AP 104, the SMD-ME 108, the client device 110, the controller 120, etc., storage medium, and logic circuit in a single computing entity, such as entirely within a single device. Alternatively, the communications device 900 may distribute portions of the structure and/or operations using a distributed system architecture, such as a client station server architecture, a peer-to-peer architecture, a master-slave architecture, etc.

A radio interface 910, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 910 may include, for example, a receiver 915 and/or a transmitter 920. The radio interface 910 may include bias controls, a crystal oscillator, and/or one or more antennas 925. In additional or alternative configurations, the radio interface 910 may use oscillators and/or one or more filters, as desired.

The baseband circuitry 930 may communicate with the radio interface 910 to process, receive, and/or transmit signals and may include, for example, an Analog-To-Digital Converter (ADC) for down converting received signals with a Digital-To-Analog Converter (DAC) 935 for up converting signals for transmission. Further, the baseband circuitry 930 may include a baseband or PHY layer processing circuit for the PHY link layer processing of respective receive/transmit signals. Baseband circuitry 930 may include, for example, a MAC processing circuit 940 for MAC/data link layer processing. Baseband circuitry 930 may include a memory controller for communicating with MAC processing circuit 940 and/or a computing device 800, for example, via one or more interfaces 945.

In some configurations, PHY processing circuit may include a frame construction and/or detection module, in combination with additional circuitry such as a buffer memory, to construct and/or deconstruct communication frames. Alternatively or in addition, MAC processing circuit 940 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method comprising:
operating, by an access point (AP) in a seamless mobility domain (SMD), as an ultra high reliability (UHR) AP managing a basic service set (BSS) in a wireless network; and
periodically transmitting, by the AP, beacon frames to advertise the BSS to one or more client devices;
wherein the beacon frames comprise a UHR element indicating that the AP supports seamless roaming within the SMD.

2. The method of claim 1, wherein:
UHR APs are mandated to support seamless roaming; and
presence of the UHR element in the beacon frames serves as the indication that the AP supports seamless roaming.

3. The method of claim 1, wherein the UHR element comprises a field indicating seamless roaming support.

4. The method of claim 3, wherein:
the UHR element is a UHR operation element comprising a UHR operation control field; and
the UHR operation control field includes a seamless roaming supported field configured to be set to a first value to indicate that seamless roaming is supported and to a second value to indicate that seamless roaming is not supported.

5. The method of claim 1, further comprising:
receiving, from a client device, a UHR capabilities element comprising a seamless roaming supported field configured to be set to a first value to indicate that the client device supports seamless roaming and set to a second value to indicate that the client device does not support seamless roaming.

6. The method of claim 1, further comprising:
receiving, from a client device, a UHR capabilities element comprising an SMD association supported field configured to indicate whether the client device supports SMD level association and an SMD BSS transition supported field configured to indicate whether the client device supports seamless roaming.

7. The method of claim 1, further comprising:
receiving, from a client device, a (re)association request comprising an SMD information element indicating that the request is a reassociation to the SMD and a pairwise master key (PMK) identifier corresponding to an SMD level PMK established during a prior SMD level association; and
performing PMK security association (PMKSA) caching-based reassociation with the client device using the SMD level PMK.

8. A system comprising:
a memory storage; and
a processing unit coupled to the memory storage, wherein the processing unit is operative to:
operate as an ultra high reliability (UHR) AP managing a basic service set (BSS) in a wireless network; and
periodically transmit beacon frames to advertise the BSS to one or more client devices;
wherein the beacon frames comprise a UHR element indicating that seamless roaming support within a seamless mobility domain (SMD).

9. The system of claim 8, wherein:
UHR APs are mandated to support seamless roaming; and
presence of the UHR element in the beacon frames serves as the indication of seamless roaming support.

10. The system of claim 8, wherein the UHR element comprises a field indicating seamless roaming support.

11. The system of claim 10, wherein:
the UHR element is a UHR operation element comprising a UHR operation control field; and
the UHR operation control field includes a seamless roaming supported field configured to be set to a first value to indicate that seamless roaming is supported and to a second value to indicate that seamless roaming is not supported.

12. The system of claim 8, wherein the processing unit is further operative to:
receive, from a client device, a UHR capabilities element comprising a seamless roaming supported field configured to be set to a first value to indicate that the client device supports seamless roaming and set to a second value to indicate that the client device does not support seamless roaming.

13. The system of claim 8, wherein the processing unit is further operative to:
receive, from a client device, a UHR capabilities element comprising an SMD association supported field configured to indicate whether the client device supports SMD level association and an SMD BSS transition supported field configured to indicate whether the client device supports seamless roaming.

14. The system of claim 8, wherein the processing unit is further operative to:
receive, from a client device, a (re)association request comprising an SMD information element indicating that the request is a reassociation to the SMD and a pairwise master key (PMK) identifier corresponding to an SMD level PMK established during a prior SMD level association; and
perform PMK security association (PMKSA) caching-based reassociation with the client device using the SMD level PMK.

15. A non-transitory computer-readable medium that stores a set of instructions which when executed by a processing unit, cause the processing unit to perform a method comprising:
operating as an ultra high reliability (UHR) AP managing a basic service set (BSS) in a wireless network; and
periodically transmitting beacon frames to advertise the BSS to one or more client devices;
wherein the beacon frames comprise a UHR element indicating seamless roaming support within a seamless mobility domain (SMD).

16. The non-transitory computer-readable medium of claim 15, wherein:
UHR APs are mandated to support seamless roaming; and
presence of the UHR element in the beacon frames serves as the indication of seamless roaming support.

17. The non-transitory computer-readable medium of claim 15, wherein the UHR element comprises a field indicating seamless roaming support.

18. The non-transitory computer-readable medium of claim 15, the method executed by the set of instructions further comprising:
receiving, from a client device, a UHR capabilities element comprising a seamless roaming supported field configured to be set to a first value to indicate that the client device supports seamless roaming and set to a second value to indicate that the client device does not support seamless roaming.

19. The non-transitory computer-readable medium of claim 15, the method executed by the set of instructions further comprising:
receiving, from a client device, a UHR capabilities element comprising an SMD association supported field configured to indicate whether the client device supports SMD level association and an SMD BSS transition supported field configured to indicate whether the client device supports seamless roaming.

20. The non-transitory computer-readable medium of claim 15, wherein:
receiving, from a client device, a (re)association request comprising an SMD information element indicating that the request is a reassociation to the SMD and a pairwise master key (PMK) identifier corresponding to an SMD level PMK established during a prior SMD level association; and
performing PMK security association (PMKSA) caching-based reassociation with the client device using the SMD level PMK.
